(19) United States
(12) Patent Application Publication
(10) Pub. No.: US 2007/0233421 A1
(43) Pub. Date: Oct. 4, 2007

(54) Pressure transducer

(75) Inventors: Wolfgang Scholz, Minden (DE); Peter Krippner, Karlsruhe (DE)

Correspondence Address: BUCHANAN, INGERSOLL & ROONEY PC, POST OFFICE BOX 1404, ALEXANDRIA, VA, 22313-1404, US

(73) Assignee: ABB Patent GmbH, Ladenburg (DE)

(21) Appl. No.: 11/705,469

(22) Filed: Feb. 13, 2007

(30) Foreign Application Priority Data
Feb. 14, 2006 (DE) 20 2006 002 263.5

(51) Int. Cl. G01L 7/00

(52) U.S. Cl. 702/138

(57) ABSTRACT

Exemplary embodiments are directed to processing a sensor signal using the correction parameters assigned to the sensor. A pressure transducer is disclosed for measuring and converting absolute pressure and/or differential pressure into an adequate electrical measurement signal with the aid of a processing unit having an associated read-only memory, in which is stored a set of correction parameters for correcting the measurement signal.

### RELATED APPLICATION

The present application claims the benefit under 35 U.S.C. §119 of the fling date of German Application No. 20 2006 002263.5, filed Feb. 14, 2006, the contents of which are hereby incorporate by reference in their entirety.

### FIELD

A pressure transducer is disclosed for measuring and converting absolute pressure and/or differential pressure into an adequate electrical measurement signal.

### BACKGROUND

Information exists on such pressure transducers, such as in DE 35 12 529 A1, which for example, describes such devices in detail.

The electrical signal S, which is generated in the conversion of the non-electrical quantity differential pressure dp=p1−p2, being the difference of a first process pressure p1 and a second process pressure p2, into an electrical quantity, exhibits dependencies S₂=f(p) on the absolute pressure p=(p1+p2)/2 and S₃=f(θ) on the temperature θ inside the differential pressure transducer, which exist in addition to the dependency S₁=f(dp) as a result of given material constants. The electrical signal S=f(dp,p,θ) is a function of the differential pressure dp, of the absolute pressure p and of the temperature θ. The dependency of the electrical signal S on the absolute pressure p and temperature θ can distort a converted measured value.

EP 0 178 368 A2, which is based on a sensor arrangement having a differential pressure sensor, a temperature sensor and a sensor for the static pressure, discloses calculating a corrected differential pressure signal using a linear polynomial function linking the three original measurement signals that can be detected at the sensors for differential pressure, temperature and static pressure. For this purpose, the coefficients of the polynomial function, which are weighted functions of the temperature and static pressure, are stored in a read-only memory.

Irrespective of the manner of the correction, this read-only memory is physically assigned to the means of correction, usually a microprocessor, and hence is physically separate or separable from the sensor arrangement.

Depending on the manufacturing process, but in particular during repairs, there is a risk that the pairing of a sensor arrangement with the associated read-only memory containing the associated set of correction parameters is lost. As a result, measured values are processed incorrectly, but not corrected.

DE 201 05 505 U1 discloses an electronic analysis circuit situated directly beside the measurement cell in the oil-filled pressure chamber. The electronic analysis circuit is subjected to the process pressure. The permitted measurement range of the pressure transducer is limited by the allowed pressure that can be applied to the components of the electronic analysis circuit.

### SUMMARY

Exemplary embodiments are directed to processing a sensor signal solely using the correction parameters assigned to the sensor. A pressure transducer is disclosed for measuring and converting absolute pressure and/or differential pressure and converting into an adequate electrical measurement signal with the aid of a processing unit having an associated read-only memory, in which is stored a set of correction parameters for correcting the measurement signal.

The read-only memory can be inseparably connected to the sensor arrangement, and detachably connected to the processing unit.

This can ensure that the correction parameters are inevitably kept with the sensor of the sensor arrangement, thereby eliminating any mistakes or incorrect assignments between sensor and correction parameters.

The read-only memory can have a serial data interface. This can keep down the number of connection leads emanating from inside the sensor arrangement.

An A/D converter can be provided and inseparably connected to the sensor arrangement, the A/D converter being connected to the serial data interface.

The sensor arrangement can be inseparably connected to a microcontroller, which is connected to the serial data interface, and in which an address-decoding program is loaded for the read-only memory and the A/D converter.

### BRIEF DESCRIPTION OF THE DRAWINGS

Exemplary embodiments will be described herein with reference to drawings in which:

FIG. 1 shows a schematic cross-section of an exemplary sensor arrangement in a transducer; and

FIG. 2 shows a block diagram of an exemplary measurement signal processing.

### DETAILED DESCRIPTION

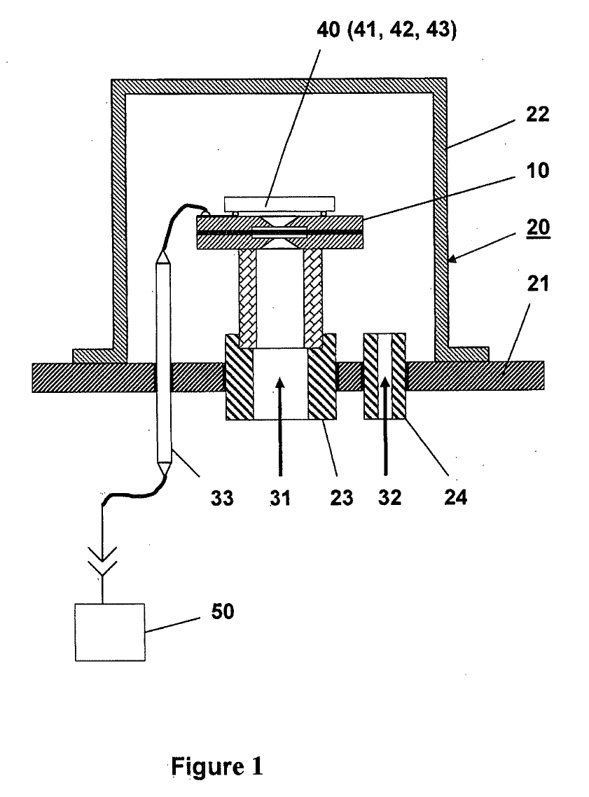

FIG. 1 shows a cross-sectional view of a sensor arrangement. This essentially comprises a differential pressure sensor 10 having a first and a second pressure inlet, which is located in an oil-filled housing 20 comprising a housing base 21 and a housing cover 22. A first pressure port 23 for admitting a first process pressure 31 is fitted in the housing base 21, the differential pressure sensor 10 being mounted on this pressure port. The first process pressure 31 acts on the first pressure inlet of the differential pressure sensor 10 via a chemical seal.

In addition, a second pressure port 24 for admitting a second process pressure 32 is fitted in the housing base 21. The second process pressure 32 acts on the second pressure inlet of the differential pressure sensor 10 via the oil in the housing.

An electronic circuit 40 is mounted on the differential pressure sensor 10. It contains at least one read-only memory 41, which can be permanently assigned to the differential pressure sensor 10 and inseparably connected (e.g., fixedly connected so as not to be configured for ready detachment) to the differential pressure sensor 10. A set of correction parameters for correcting the measurement signal is stored in the read-only memory 41. By this means, if the sensor arrangement is replaced during repair, the associated correction parameters are inevitably replaced as well. This avoids a measurement signal being distorted by applying correction parameters from a different differential pressure sensor 10.

The differential pressure sensor 10 is detachably connected to a processing unit 50 located outside the housing 20. For this purpose, connection leads emanating from the differential pressure sensor 10 are taken out of the housing 20 via contact pins 33 fitted in the housing base 21 and insulated from it. The processing unit 50 is connected to these contact pins 33. A serial protocol is provided for communication between the differential pressure sensor 10 and the processing unit 50, so that it is possible to manage with a small number of contact pins 33 designed as electrical feedthroughs.

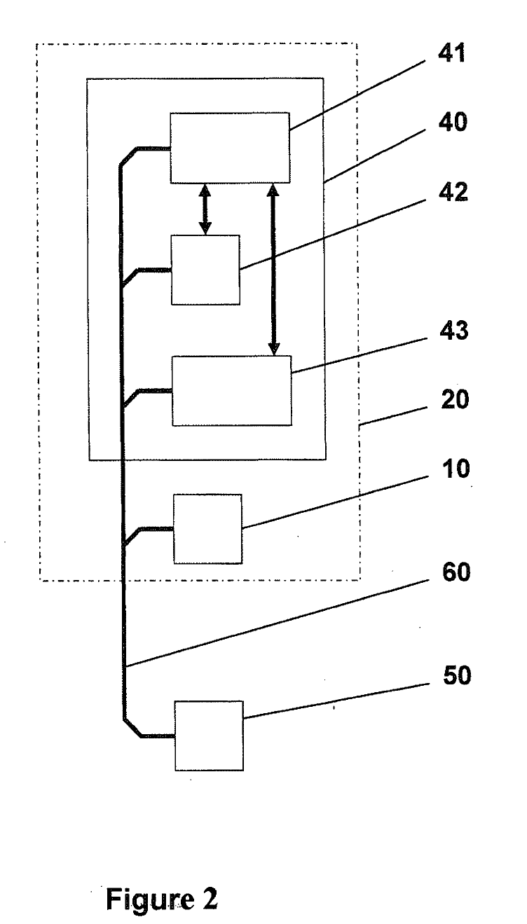

FIG. 2 shows a block diagram of the measurement signal processing, where the same references are used for the same means. The differential pressure sensor 10 and the electronic circuit 40 are arranged in the housing 20 and connected via a serial data interface 60. The processing unit 50 can be detachably connected to the serial data interface 60 outside the housing 20.

In a first exemplary embodiment, the electronic circuit 40 has a read-only memory 41, in which is stored a set of correction parameters for correcting the measurement signal.

In another embodiment, the electronic circuit 40 also comprises an A/D converter 42, which is inseparably connected to the differential pressure sensor 10. The A/D converter 42 is connected to the serial data interface 60. The analog differential pressure signal is thereby digitized directly in the differential pressure sensor 10, and transmitted in digitally encoded form via the serial data interface 60 to the processing unit 50 located outside the housing 20. The transmission of digitally encoded signals can be less sensitive to noise than the transmission of analog signals. Such a feature can be particularly relevant to the use of pressure transducers of the type in question in the industrial environment.

In a further embodiment, it is provided that the electronic circuit 40 comprises a microcontroller 43, which is connected to the serial data interface 60. An address-decoding program for the read-only memory 41 and the A/D converter 42 is loaded in the microcontroller 43. Despite a large number of devices in the electronic circuit 40, it can thereby be possible to manage with a small number of contact pins 33 designed as electrical feedthroughs.

It is also possible using these means to operate different bus systems over the same communications channel. The protocol of the bus system currently in use can be detected and applied by the microcontroller 43.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCES

10 differential pressure sensor
20 housing
21 housing base
22 housing cover
23 first pressure port
24 second pressure port
31 first process pressure
32 second process pressure
33 contact pin
40 electronic circuit
41 read-only memory
42 A/D converter
43 microcontroller
50 processing unit
60 serial data interface

1. A pressure transducer for measuring and converting absolute pressure and/or differential pressure into an adequate electrical measurement signal, comprising:
a sensor arrangement having at least one sensor;
a processing unit; and
a read-only memory, in which is stored a set of correction parameters for correcting the measurement signal, wherein the sensor arrangement is inseparably connected to the read-only memory and detachably connected to the processing unit.

2. The pressure transducer as claimed in claim 1,
wherein the read-only memory and the processing unit are connected via a serial data interface

3. The pressure transducer as claimed in claim 2, comprising:
an A/D converter inseparably connected to the sensor arrangement, the A/D converter being connected to the serial data interface.

4. The pressure transducer as claimed in claim 3,
wherein the sensor arrangement is inseparably connected to a microcontroller, which is connected to the serial data interface, and in which an address-decoding program is loaded for the read-only memory and the A/D converter.
